(19) United States
(12) Patent Application Publication
(10) Pub. No.: US 2017/0063147 A1
(43) Pub. Date: Mar. 2, 2017

(54) POWER SOURCE SYSTEM

(71) Applicant: JGC CORPORATION, Tokyo (JP)

(72) Inventors: Tomonori NAKAYAMA, Ibaraki (JP); Masayoshi ISHIDA, Ibaraki (JP); Masahisa TODA, Ibaraki (JP); Shinji TAKAHASHI, Kanagawa (JP); Hiroaki HASEGAWA, Kanagawa (JP); Kazutaka HIRAOKA, Kanagawa (JP); Nobuo KAKIZAKI, Kanagawa (JP)

(73) Assignee: JGC CORPORATION, Tokyo (JP)

(21) Appl. No.: 15/123,250

(22) PCT Filed: Mar. 4, 2015
(86) PCT No.: PCT/JP2015/001149

§ 371 Date: Sep. 2, 2016

(30) Foreign Application Priority Data
Mar. 4, 2014 (JP) 2014-041764

(51) Int. Cl. H02J 7/35; H02J 3/38; H02J 3/46; H02J 7/00

(52) U.S. Cl. CPC H02J 7/35; H02J 7/0068; H02J 3/386; H02J 3/383; H02J 3/46

(57) ABSTRACT

A power source system includes: a power storage device; a switch portion for connecting or disconnecting the power storage device to or from outside; a converter for converting electric power output from a power generation apparatus into external power; and a control unit for controlling a connection or disconnection operation of the switch portion, in which the control unit is for: disconnecting, when an output current of the power generation apparatus is low current, connection between the power storage device and the outside to charge the power storage device with the electric power output from the power generation apparatus; and controlling, when a voltage of the power storage device becomes higher than an operating voltage of the converter as a result of the charging, the connection or disconnection operation of the switch portion so as to connect the power storage device and the converter to output the stored electric power.

### TECHNICAL FIELD

The present disclosure relates to a power source system, which is configured to receive electric power from a power source having a varying output, and to supply electric power to the outside.

### BACKGROUND ART

In view of environmental problems, development of power source apparatus intended to recover sunlight, wind power, wave power, tidal power, tidal energy, and other such natural energy has been pursued in recent years. However, power generation methods that use natural energy have the drawbacks that an energy density is low, and that the output of electric power generated in those methods is affected by weather conditions and is thereby varied, preventing electric power from being stably supplied at all times.

For example, in Patent Literature 1 listed below, there is disclosed a direct current (DC) power source apparatus including a power converter configured to convert the output of a photovoltaic cell into electric power, which is configured to supply, together with a main power source apparatus configured to output a constant voltage, DC power to load equipment via a DC supply line. Moreover, an output voltage and an output current of the photovoltaic cell are intermittently acquired via communication, and a current command value for adjusting an output current of the power converter is intermittently supplied via communication. Further, as a power source management part, there is disclosed a microcomputer (“power source management part”) including a main search part configured to search a specific search range for a voltage corresponding to the maximum output point of the photovoltaic cell, and a voltage maintaining part configured to use the voltage determined by the main search part as a target voltage, and to supply the current command value, which is set so that the output voltage of the photovoltaic cell is maintained at the target voltage, to the above-mentioned DC power source apparatus.

Incidentally, in Patent Literature 2 listed below, there is disclosed an unmanned transportation vehicle on which a battery device 300 formed of a vehicle-side connecting electrode, a capacitor, a DC-DC converter, and the like is mounted. A ground-side electric double layer capacitor which is charged with the electric power of a commercial power source via a switching power source, or the like, is arranged as a ground-side charging device. In order to charge the vehicle side, the charged ground-side electric double layer capacitor and the vehicle-side electric double layer capacitor are connected, with the result that the charging of the vehicle-side electric double layer capacitor is finished in a very short time.

Further, in Patent Literature 2 listed below, the following description is provided: “although the electric double layer capacitor is used as a specific example of a capacitor, a lithium-ion capacitor may be used instead of the electric double layer capacitor. (Patent Literature 2, paragraph [0070])”.

### CITATION LIST

### Patent Literature

[Patent Literature 1] JP 2010-231456 A

[Patent Literature 1] JP 2010-004587 A

### SUMMARY

### Technical Problem

In the DC power source system disclosed in Patent Literature 1, as can be seen from the following description: “when an amount of electric power generation of a photovoltaic cell 11 exceeds electric power required by the power converter 13, excess power is stored in a smoothing capacitor 12 to suppress an increase in output power of the power converter 13, and when the amount of electric power generation of the photovoltaic cell 11 is not sufficient for electric power required by the power converter 13, charges stored in the smoothing capacitor 12 are discharged to suppress a decrease in output power of the power converter 13. As the smoothing capacitor 12, an electric double layer capacitor (EDLC) is used”, the EDLC is provided before the power converter in order to store the excess power. In this manner, in Patent Literature 1, a description is given of an aspect in which smoothing is performed when the output of the photovoltaic cell is high.

Incidentally, photovoltaic power generation and wind power generation are expected as renewable and clean power generation sources and increasingly introduced, but have times when the output becomes lower, such as in the morning and the night and when it is cloudy or rainy for the photovoltaic power generation, and when a wind velocity is low for the wind power generation.

A power conditioner is a device configured to convert generated electricity into a commercial power source, and is a kind of inverter. The electricity generated by a solar panel or the like is generally a “direct current”, and the power conditioner is configured to convert the direct current into an “alternating current”, which is used in general houses in Japan, and hence into generally usable electricity. The power conditioner is designed to have increased efficiency at around a designed rating, and hence ratings of power generation apparatus for the photovoltaic power generation, the wind power generation, and the like to be connected to the power conditioner are selected to be around the rating of the power conditioner. However, when the outputs of those power generation apparatus become lower, the efficiency is reduced due to switching loss, forward power loss caused by a voltage drop of a semiconductor, or the like. Therefore, loss of many power generation opportunities throughout the year and loss due to the decrease in power conversion efficiency of the power converter caused by a partial load state result.

As described above, the conventionally proposed devices configured to store electric power generated by natural energy cannot recover and output electric power efficiently when electric power is reduced.

A power source system according to one embodiment of the present disclosure has an object of recovering a low current output from a power source having a varying output by a power storage device, and of outputting electric power at a rated value to allow unused energy to be used and output at high efficiency.

### Solution to Problem

Modes to solve the above-mentioned problem are realized in the following items.

Item A1. A power source system, which is configured to receive electric power from a power generation apparatus having a varying output, and to convert the received electric power into external power for output, including:

a power storage device having a larger amount of stored electric power and/or a lower self-discharge rate than a capacitor element serving as a passive element, and higher charge and discharge efficiency and/or higher responsiveness than a secondary battery, the power storage device being configured to store electric power of the power generation apparatus, and to discharge the stored electric power;

a switch portion configured to connect or disconnect the power storage device to or from outside;

a converter configured to convert the electric power output from the power generation apparatus into the external power; and

a control unit configured to control a connection or disconnection operation of the switch portion,

in which the control unit is configured to:
disconnect, when an output current of the power generation apparatus is low current, connection between the power storage device and the outside to charge the power storage device with the electric power output from the power generation apparatus; and
control, when a voltage of the power storage device becomes higher than an operating voltage of the converter as a result of the charging, the connection or disconnection operation of the switch portion so as to connect the power storage device and the converter to output the stored electric power to the outside.

Item A2. A power source system described in Item A1, further including a battery device arranged between the converter and the power storage device,

in which the battery device further includes a battery device configured to store electric power at a voltage that is lower than a voltage of the electric power discharged from the power storage device.

Item A3. A power source system described in any one of Items A1 to A3, in which the control unit is configured to calculate electric power of the power generation apparatus using a first voltage sensor and a second current sensor, and to control the switch portion so as to maximize electric power from the power generation apparatus.

Item A4. A power source system described in any one of Items A1 to A3, in which the power storage device is a lithium-ion capacitor or an electric double layer capacitor.

A5. A power source system described in any one of Items A1 to A4, in which the power generation apparatus is a photovoltaic power generation apparatus or a wind power generation apparatus.

Item B1. A power source system, which is configured to receive electric power from a power generation apparatus having a varying output, and to convert the received electric power into external power for output, including:

a power storage device having a larger amount of stored electric power and/or a lower self-discharge rate than a capacitor element serving as a passive element, which is configured to store electric power of the power generation apparatus, and to discharge the stored electric power;

a first switch portion configured to connect or disconnect the power storage device to or from outside;

a converter configured to convert the electric power output from the power generation apparatus into the external power; and

a control unit configured to control a connection or disconnection operation of the first switch portion,

in which the control unit is configured to:
disconnect, when an output current of the power generation apparatus is low current, connection between the power storage device and the outside to charge the power storage device with the electric power output from the power generation apparatus; and
control, when a voltage of the power storage device becomes higher than an operating voltage of the converter as a result of the charging, the connection or disconnection operation of the first switch portion so as to connect the power storage device and the converter to output the stored electric power to the outside.

Item B2. A power source system described in Item B1, further including a battery device arranged between the converter and the power storage device,

in which the battery device further includes a battery device configured to store electric power at a voltage that is lower than a voltage of the electric power discharged from the power storage device.

Item B3. A power source system described in Item B1 or B2, in which the control unit is configured to calculate electric power of the power generation apparatus using a first voltage sensor and a second current sensor, and to control the first switch portion so as to maximize electric power from the power generation apparatus.

Item B4. A power source system described in any one of Items B1 to B3, further including a second switch portion configured to connect or disconnect the converter to or from the power generation apparatus,

in which the control unit is configured to:
disconnect the first switch portion and connect the second switch portion when electric power of the power generation apparatus is changed to fall below a lower limit value of a rated input range of the converter, or when power conversion efficiency of the converter is significantly reduced; and
perform control so that the first switch portion and the second switch portion are connected to discharge the electric power stored in the power storage device when, as a result of connecting the first switch, a voltage of the power storage device falls within an MPPT control voltage range of the converter, and

in which the power storage device is configured so that the electric power output from the power storage device falls within a rated input range of the converter during the discharging.

Item B5. A power source system described in any one of Items B1 to B4, in which the power storage device has an internal resistance with which the electric power does not fall outside a rated output range of the converter due to a voltage drop of the power storage device during the discharging.

Item B6. A power source system described in Item B5, in which the power storage device is formed of a plurality of power storage modules, and the plurality of power storage modules are connected in parallel.

Item B7. A power source system described in any one of Items B1 to B6, in which the converter is configured to control the electric current so that the electric power does not fall outside a rated input range of the converter due to a voltage drop of the power storage device during the discharging of the power storage device.

Item B8. A power source system described in any one of Items B1 to B7, in which when the maximum power conversion efficiency of the converter is set to 1, the rated output range is a range in which the power conversion efficiency of the converter is 80% to 100% of a rating of the converter.

Item B9. A power source system described in any one of Items B1 to B8, in which the control unit is configured to, after the discharging and before a voltage of the electric power output from the power storage device becomes a lower limit value of a rated input range of the converter, disconnect the first switch portion and connect the second switch portion to stop the discharging.

Item B10. A power source system described in any one of Items B4 to B9, in which the control unit is configured to, when electric power of the power generation apparatus is changed to exceed an upper limit of a rated input range of the converter, connect the first switch portion and the second switch portion.

Item B11. A power source system described in any one of Items B1 to B10, in which the power storage device has higher charge and discharge efficiency and/or higher responsiveness than a secondary battery.

Item B12. A power source system described in any one of Items B1 to B10, in which the power storage device is a lithium-ion capacitor or an electric double layer capacitor.

Item B13. A power source system described in any one of Items B1 to B10, in which the power storage device is a secondary battery.

Item B14. A power source system described in any one of Items B1 to B13, in which the power generation apparatus is a photovoltaic power generation apparatus or a wind power generation apparatus.

The power source system according to the one embodiment of the present disclosure is capable of recovering a low current output from the power source having a varying output by the power storage device, and of outputting at the rated value to allow unused energy to be used and output at high efficiency.

### BRIEF DESCRIPTION OF DRAWINGS

FIG. 1 is a single-line diagram for illustrating an example of a power source system according to an embodiment of the present disclosure.

FIG. 2 is a diagram for illustrating a “shishi-odoshi (scaredeer)”.

FIG. 3A is a graph for showing various devices configured to store energy.

FIG. 3B is a graph for showing a relationship between a solar irradiance and power generation curves.

FIG. 4 is a flow chart for illustrating control processing of a control unit.

FIG. 5A is a graph for showing an example of charge and discharge curves of a power storage device according to an embodiment of the present disclosure.

FIG. 5B is a graph for showing an example of output during discharging of the power storage device according to an embodiment of the present disclosure.

FIG. 5C is a graph for showing an example of output during discharging of a related-art battery.

FIG. 5D is a graph for showing a recovery mode under high load.

FIG. 6 is an illustration of an example of a battery configuration of a power storage device according to an embodiment of the present disclosure.

FIG. 7 is a single-line diagram for illustrating an example of a power source system according to an embodiment of the present disclosure.

FIG. 8 is an electric circuit diagram for illustrating a detailed example of the power source system applied to a wind power generator.

FIG. 9 is a graph for showing a relationship between wind power generation and wind velocities.

FIG. 10 is a graph for showing an example of electric power generated in the wind power generation and electric power receiving capacity of the power source system.

FIG. 11 is a graph for showing a solar irradiance obtained from an actinometer.

FIG. 12 is a graph for showing a measurement result of conversion efficiency in accordance with the solar irradiance.

FIG. 13 is a graph for showing a result of a conversion efficiency improvement test under partial load of a converter.

### DESCRIPTION OF EMBODIMENTS

Now, a power source system according to embodiments of the present disclosure is described in detail with reference to the drawings. As examples of power generation apparatus having a varying output, there are given photovoltaic power generation apparatus, wind power generation apparatus, hydraulic power generation apparatus, wave activated power generation apparatus, tidal power generation apparatus, tidal energy power generation apparatus and vibration power generation apparatus.

1. Power Source System

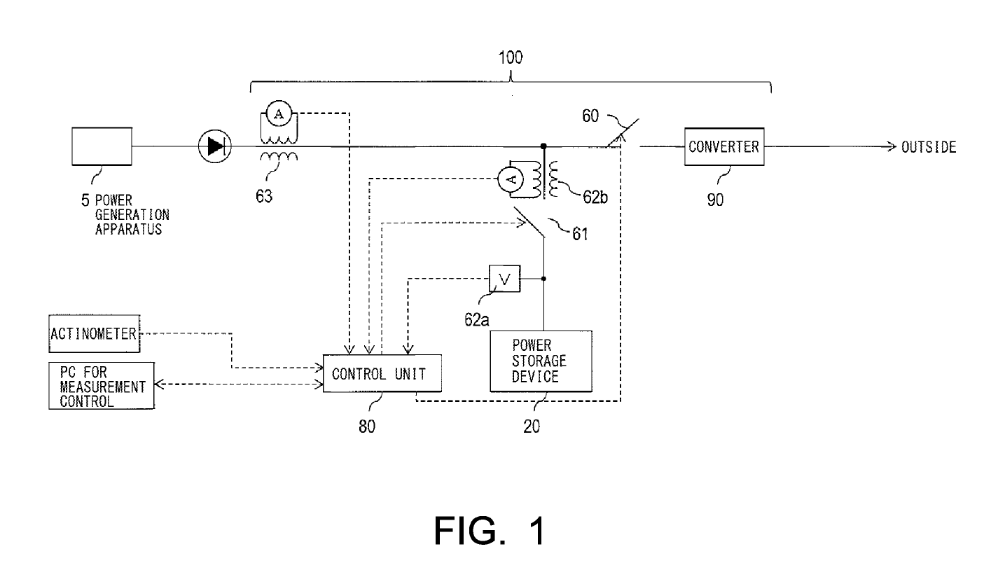

FIG. 1 is a single-line diagram for illustrating an example of the power source system according to an embodiment of the present disclosure. A power source system 100 according to this embodiment, which is illustrated in FIG. 1, is a power source system configured to receive electric power from a power generation apparatus 5 having a varying output, and to supply electric power to the outside, and includes a power storage device 20, a switch 60, a control unit 80, and a converter 90.

The power source system 100 further includes a voltage sensor 62A configured to measure a voltage of the power storage device 20, a current sensor 62B configured to measure input and output currents of the power storage device 20, and a current sensor 63 configured to measure an output current of the power generation apparatus. The current sensor 63 is not an essential component, and when there is another unit configured to measure the output current of the power generation apparatus, is replaced by the unit. For example, as illustrated in FIG. 1, when the power generation apparatus performs photovoltaic power generation (hereinafter also referred to as “PV”), the current sensor 63 is an actinometer.

Now, the constituent elements of the power source system 100 are described.

2. Power Storage Device

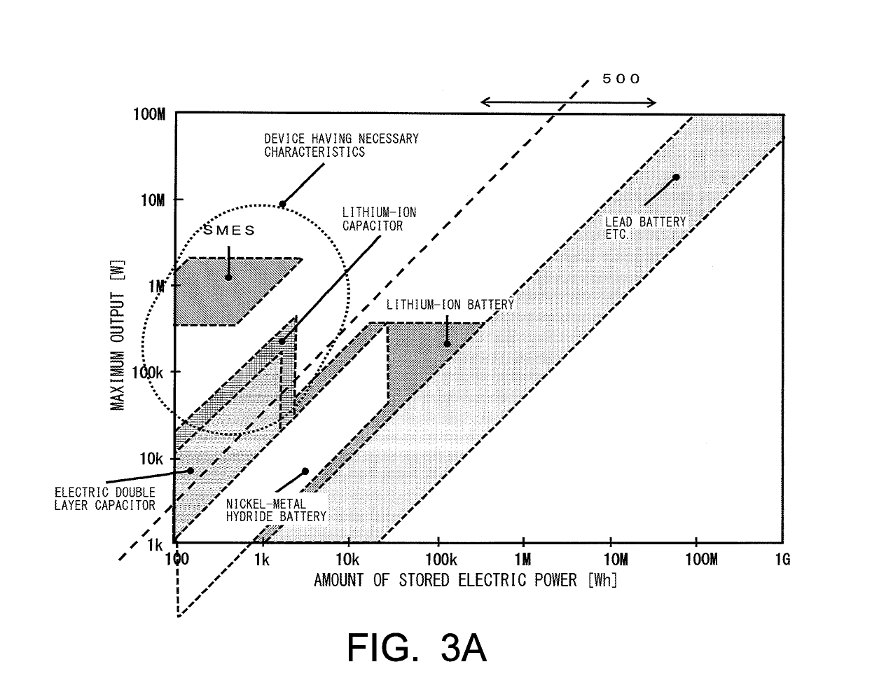

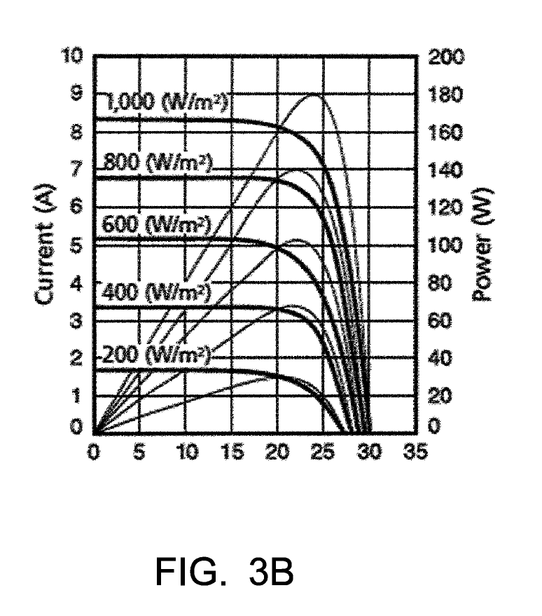

FIG. 3A is a graph for showing various devices configured to store energy. In Table 1, a lithium-ion capacitor, a superconducting magnet energy storage (SMES), an electric double layer capacitor, and a nickel-metal hydride battery, a lithium-ion battery, and a lead battery etc., which function as secondary batteries, are shown. On the left side of the dashed line 500, devices having a small DC resistance and high charge and discharge efficiency are shown, and on the right side of the dashed line 500, devices having a large DC resistance and low charge and discharge efficiency are shown.

As shown in the graph, those devices are classified by an amount of stored electric power [WH] and the maximum output [W]. Those devices are also classified by input/output responsiveness or the charge and discharge efficiency as described below.

A. Input/Output Responsiveness

As is well known, there is a positive correlation between the input/output responsiveness of the power storage device and a rated electric output of the power storage device. In other words, as the rated electric output of the power storage device becomes larger, the input/output responsiveness of the power storage device becomes higher, and as the rated electric output of the power storage device becomes smaller, the input/output responsiveness of the power storage device becomes lower.

B. Charge and Discharge Efficiency

As is also well known, there is a negative correlation between the charge and discharge efficiency of the power storage device and the DC resistance of the power storage device. In other words, as the DC resistance of the power storage device becomes smaller, the charge and discharge efficiency of the power storage device becomes higher, and as the DC resistance of the power storage device becomes larger, the charge and discharge efficiency of the power storage device becomes lower. Note that, capacitors used as passive elements in an electric circuit have an extremely small amount of stored electric power, and hence those capacitors cannot be shown.

Table 1 is a table for showing the responsiveness, the charge and discharge efficiency, and self-discharge rates of power storage devices according to Example 1. The power storage devices applied to the power source system according to the present disclosure are configured so that, even when the output of one of a plurality of power sources having varying outputs drops, another power source operates at a maximum power point thereof, and that even if the output of the power source drops, electric power is maintained by stored power. Moreover, when the electric power of the power source frequently changes, and when charge and discharge efficiency is low, a loss occurs in the electric power generated by the power source. In view of this, the power storage device applied to the power source system according to the present disclosure has high charge and discharge efficiency.

TABLE 1

| | Lithium-ion | | Electric double |
|---|---|---|---|
| | capacitor | SMES | layer capacitor |
| Responsiveness = | ⊚ | ⊚ | ⊚ |
| output density [W/kg] | 1000~10000 | 10000~100000 | 700~1200 |
| Charge and discharge | 98~99 | 98~99 | 98~99 |
| efficiency [%] = | ⊚ | ⊚ | ⊚ |
| DC resistance | (low | | |
| characteristics | resistance) | | |
| Self-discharge | 3~5 | 0~1 | 50~75 |
| rate [%/month] | | | |
| | Lithium-ion | Nickel-metal | |
| | battery | hydride battery | Lead battery |
| Responsiveness = | ◯ | ◯ | Δ |
| output density [W/kg] | 250~1000 | 250~1000 | 150~250 |
| Charge and discharge | 80~90 | 60~70 | 50~90 |
| efficiency [%] = | ◯ | ◯ | Δ |
| DC resistance | | | (high |
| characteristics | | | resistance) |
| Self-discharge | 5~15 | 25~35 | 3~20 |
| rate [%/month] | | | |
| | Aluminum | | |
| | electrolytic | Ceramic | Teflon |
| | capacitor | capacitor | capacitor |
| Self-discharge rate | 63%/second | 45%/minute | 46%/week |

Note that, the power storage device according to Example 2 is a secondary battery, which is less expensive for the same storage capacity, stores a larger amount of energy, and is more compact than Table 1, and is a lithium-ion battery (LIB), for example. The LiB has small changes in voltage at the time of fully charged and at the time when discharging is finished for the same storage capacity as that of a lithium-ion capacitor (LiC), for example. When a range of voltages output from a power generator is small to some extent, such as only at low irradiation and at low wind velocity, the LiB is easier to control.

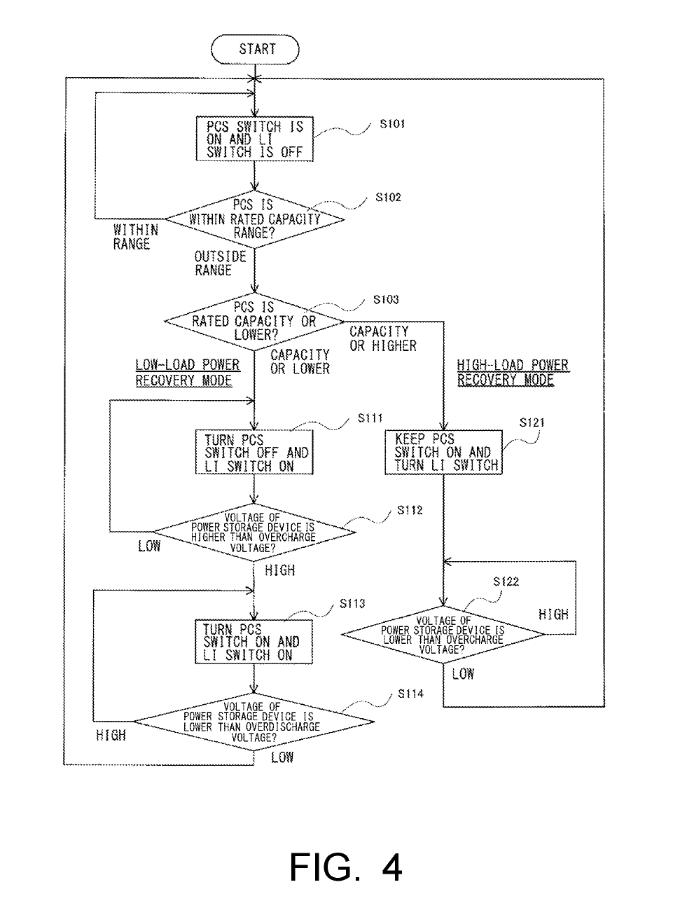

Meanwhile, the power storage device according to Example 2 has lower charge and discharge efficiency and/or lower responsiveness than the device according to Example 1. This drawback is mitigated by configuring the LiB for the power source system 100, and by control to be described later with reference to FIG. 4.

C. Amount of Stored Electric Power and Self-Discharge Rate

Moreover, as with a capacitor (also referred to as “capacitor element”) used as a passive element in the electric circuit, when the amount of stored electric power is small and the self-discharge rate [%/month] is high, a voltage quickly drops due to a discharge, and hence other power storage devices cannot operate at the maximum power point for a long period of time. Therefore, the power storage device applied to the power source system according to the present disclosure is required to have a self-discharge rate that is low enough to maintain the voltage with stored power and to essentially eliminate self-discharge.

As described above, the “lithium-ion capacitor” and the “electric double layer capacitor” have a larger amount of stored electric power and/or a lower self-discharge rate than the capacitor element used as the passive element, and also have higher charge and discharge efficiency and/or higher responsiveness than the secondary battery.

The power storage device applied to the power source system according to the present disclosure is required to have high input/output responsiveness, the high charge and discharge efficiency, the amount of stored electric power enough to maintain the voltage with the stored power, and the low self-discharge rate, and hence corresponds to the “lithium-ion capacitor” or the “SMES” shown in FIG. 3A.

It should be noted, however, that in an environment in which a state of the power generation apparatus in the power source system according to the present disclosure generating power at low electric power is anticipated, self-discharge at the level of the electric double layer capacitor may be applied. For example, examples of the environment in which the state of the power generation apparatus generating power at low electric power is anticipated are the morning and the night, cloudy and rainy weather, and a case where the frequency of appearance of the wind velocity is known in the power generation of the photovoltaic power generation and wind power generation.

3. Switch Portion

The switch 60 (also referred to as a “first switch” or a “PCS switch”) is configured to connect or disconnect the power storage device 20 to or from the outside in accordance with an instruction from the control unit 80. A switch 61 (also referred to as a “second switch” or an “LI switch”) is configured to connect or disconnect the power storage device 20 to or from the converter 90 depending on power conversion efficiency of the converter 90, which is changed with electric power output from the power generation apparatus 5, in accordance with an instruction from the control unit 80.

4. Converter

The converter 90 is a DC to AC converter, and/or a power converter for converting a voltage, and is configured to control an electric current output to the outside. The converter 90 is a power conditioning system (PCS), for example. The converter 90 includes a switching element for controlling the electric current, a step-up circuit, a step-down circuit, and a circuit control unit, for example. The switching element for controlling the electric current is formed, for example, of a metal-oxide-semiconductor field-effect transistor (MOSFET) or the like, and the circuit control unit is configured to perform pulse width modulation (PWM) control in accordance with a control signal supplied from the control unit 80 to control an amount of output current. The step-up circuit is configured to step up a voltage of the power storage device 20 when the voltage is lower than an external voltage, and the step-down circuit is configured to step down the voltage of the power storage device 20 when the voltage is higher than the external voltage.

The converter 90 has a width of input rated voltages and a feature of providing no output unless a voltage in the voltage width is applied. As a result of this feature, no output is provided for an input voltage other than the input rated voltages, and an opportunity loss occurs. The switching element such as the MOSFET also has a loss due to a control circuit, which is a power source circuit configured to turn the switching element ON/OFF, and the loss is constant to some extent as compared to an electric current or a voltage of a main circuit, with the result that a proportion of the loss is increased when an output of the main circuit is low. In this manner, the converter 90 has an increased loss at the time of power conversion when input and output power is lower than rated power thereof.

For example, in a PCS for PV, a conversion efficiency curve with respect to the output power is publicized as a data sheet and the like, but a conversion efficiency curve for a solar irradiance under sunlight, which is an input source of PV, is changed depending on the structure and specifications of a solar panel connected to the PCS, and is not a known property.

In an embodiment of the present disclosure, in order to reduce the above-mentioned converter loss, the control unit is configured to control the switches so that operating power of the converter 90 approaches the rated power.

5. Control Unit

The control unit 80 is configured to, when the output current of the power generation apparatus 5 is low, for example, when a low current is detected by the current sensor 63, control the switch 60 to disconnect the connection between the power storage device 20 and the outside, and to charge the power storage device 20 with the electric power output from the power generation apparatus 5. The control unit 80 is further configured to control the operation to connect or disconnect the switch 60 so that the power storage device 20 and the converter 90 are connected to output the stored power to the outside when the voltage of the power storage device 20 becomes higher than an operating voltage of the converter 90 as a result of the charging (“low-load power recovery mode” to be described later with reference to FIG. 4).

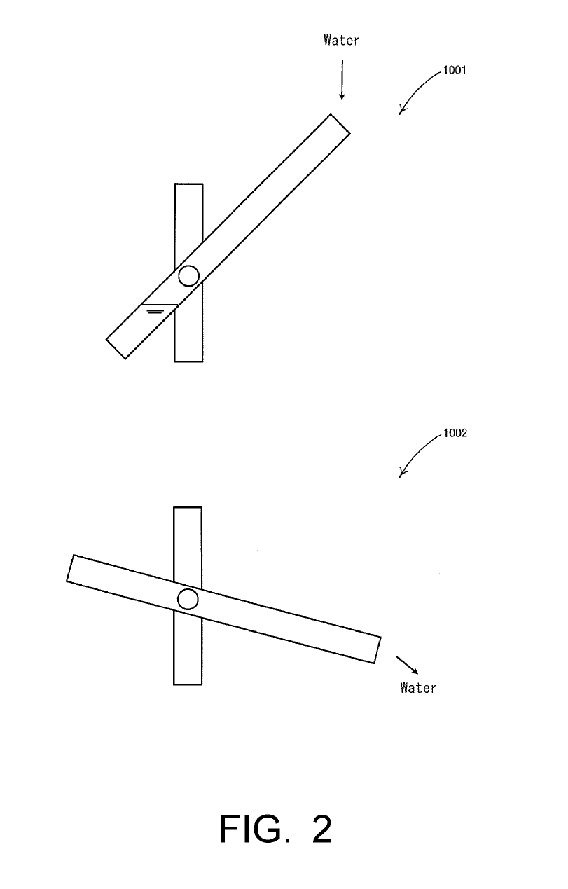

FIG. 2 is a diagram for illustrating a “shishi-odoshi (scaredeer)”. The Applicants have named the control operation as described above “shishi-odoshi” control.

Note that, in the “shishi-odoshi”, as illustrated with the reference numeral 1001, water is poured into a bamboo tube, which is supported at a fulcrum provided at around the center and has one end opened upward. Then, as illustrated with the reference numeral 1002, when the water is full, the bamboo tube is inclined with the weight of the water to spill the water and empty the bamboo tube, and the bamboo tube strikes a support (rock or the like) to make a sound as the bamboo tube returns to the original inclination. In this example, the bamboo tube is the power storage device 20, and when the water is regarded as electricity, the above-mentioned control resembles the operation of the shishi-odoshi.

Moreover, in the above-mentioned control, the switches 60 and 61 operate as follows: when the power storage device 20 and the power generation apparatus 5 are connected to each other and disconnected from the outside at the same time, the switch 60 is turned OFF, and the switch 61 is turned ON, and when the power storage device 20 is connected to the outside, the switches 60 and 61 are turned ON. Therefore, in order to keep an operating voltage of the power storage device 20 as a result of the charging of the power storage device 20 from the power generation apparatus 5 or the discharging from the power storage device 20 to the converter 90 within a predetermined width, the switch 61 connects or disconnects the power generation apparatus 5 to or from the converter 90.

Moreover, the control unit 80 has analog inputs from the current sensors 62B and 63, the voltage sensor 62A, the actinometer, and the like, and analog outputs to the switches 60 and 61.

Further, the control unit 80 is configured to charge or discharge the power storage device to control the electric current and the voltage of the power generation apparatus so that an amount of electric power generation of the power generation apparatus 5 may be maximized.

The control unit 80 includes a storage part configured to store data and control programs, and a processing part configured to perform numeric calculation processing. The storage part stores control programs for performing the control on the switches described above, and for performing maximum power point tracking (MPPT) processing, which is to be described later, and power generation data for use in a table lookup method, which is to be described later. The control unit 80 is a personal computer, a microcomputer, or a sequencer and an A/D board, for example.

The control unit 80 is configured to execute the control program to output control signals to the switches 60 and 61 based on electric signals indicating currents or voltages, which are received from the various sensors 62A, 62B, and 63, to thereby implement the MPPT processing so as to control the amount of stored electric power of the power storage device 20, and further to maximize electric power from the power generation apparatus.

In regard to the MPPT processing, the control unit 80 is configured to separately calculate electric power of the power generation apparatus 5 and electric power of the power storage device 20. During an output of 10 A in the photovoltaic power generation, for example, when 5 A is supplied to the outside, and the power storage device is charged with 5 A, and when it is determined that MPPT efficiency is increased with a reduction in voltage, the control unit 80 needs to discharge the power storage device and reduce the voltage of the power storage device, and hence to output an electric current exceeding a charge current (electric current of 5 A or higher for discharging), which is supplied to the power storage device 20, to the outside with the switch 60. Therefore, the sensor 62B on the power storage device side and the sensor 63 on the power generation apparatus side are needed as the current sensors.

A. MPPT Processing

The MPPT processing is described. Electric power is obtained as a product of an electric current and a voltage, and the voltage and the electric current may be controlled with appropriate balance to maximize a value of electric power that is retrievable. Therefore, the control unit 80 is configured to perform MPPT control (maximum power point tracking control) to change the voltage and the electric current so that the power generation apparatus may operate at the maximum power point.

The control unit 80 is configured to perform a “hill-climbing method” and/or the “table lookup method” as the MPPT control.

A hill-climbing control method is a method including detecting a voltage or electric current that is actually output from the power generation apparatus, gradually varying the electric current, and comparing electric power before and after the control to track an operation point up to the maximum power point.

The hill-climbing method in photovoltaic power generation control is described with reference to FIG. 3B. FIG. 3B is a graph for showing a relationship between the solar irradiance and power generation curves. In FIG. 3B, curves like hills are curves of electric power, and the value of the output current is changed toward the top of the curve to move a voltage point, with the result that the voltage point is seen as climbing the hill. Therefore, the method is named the “hill-climbing method”. The solar irradiance and the temperature are first determined, and the electric current is changed under the condition, with the result that the voltage is also determined. With a panel temperature of 25° C. and a solar irradiance of 600 W/M2, for example, and when the electric current is not allowed to flow, that is, when there is no load or secondary battery, the voltage becomes an open-circuit voltage of about 28 V, and the electric current becomes 0 A. Here, when a load is connected and an electric current of 4 A is allowed to flow, the voltage becomes 26 V or 17 V. When the electric current is then increased to 5 A, the voltage is reduced to about 22 V, and the maximum power point is reached. In this manner, the electric current output from the photovoltaic cell may be changed to constantly search for the maximum power point, to thereby perform the control.

In the wind power generation, electric output in the wind power generation is a mechanical load to a power generator in the wind power generation. That is, when a design is made so that electric current can be derived infinitely, that is, when an output terminal of a wind power generator is short-circuited, or when the wind power generator is placed in a state in which an ultra large current is allowed to flow into a load, a rotational force required to rotate the power generator by wind is also infinitely increased. That is, a wind mill stops rotating, and the electric output becomes 0 W. In short, even with a strong wind, a rotational speed becomes 0, that is, the output terminal is short-circuited, or becomes very high, that is, the output terminal is opened, depending on the electric current (electric power) to be retrieved.

Here, as in the photovoltaic power generation, when the electric current retrieved from the wind power generator is increased or reduced gradually, the voltage generated by the wind power generator is reduced or increased accordingly. At this time, when the electric current and the voltages are measured in advance, and an electric current at which the electric power is maximized is searched for, the hill-climbing method is achieved.

The table lookup method is a control method in which the power generation data in various situations in the photovoltaic power generation and the wind power generation is collected in advance and compiled as a table, and the table is input into an MPPT controller and referenced. The table lookup method is advantageous in that the MPPT control may be easily performed when the data has been collected in details, but is disadvantageous in that an amount of data collected in advance becomes enormous. In a case of the photovoltaic power generation, there are too many parameters, such as different types of solar radiations at different installation angles, the temperature, the solar irradiance, the number of connections in series, and the number of connections in parallel, and hence the table lookup method is difficult to use. In the wind power generation, when there is data that represents a relationship between the wind velocity and electric power, the maximum power point may be estimated relatively accurately, and hence the table lookup method is used sometimes.

In the case of the wind power generation, a wind meter is installed, and the table is referenced with respect to a wind velocity measured by the wind meter to determine an electric current that brings about the maximum electric power. As a result, the electric output in the wind power generation and a mechanical input by a wind are balanced, and the maximum electric power is output.

B. Control Processing

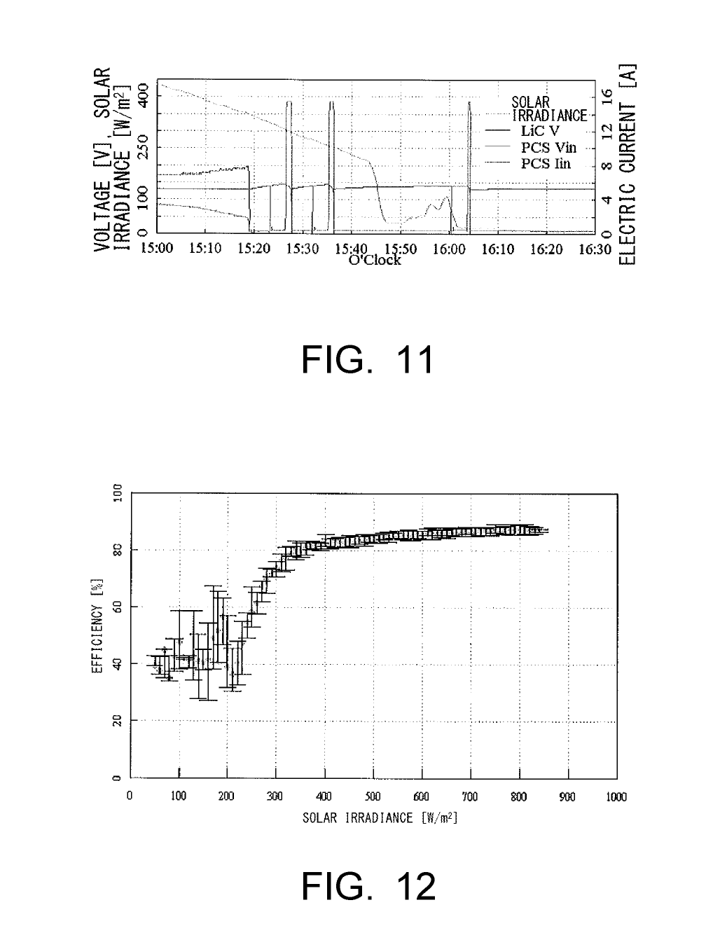

The solar irradiance from the actinometer in FIG. 11 is measured, and when the solar irradiance is 350 W/M2 or higher, it is determined that the converter 90 (PCS) provides sufficient conversion efficiency. As a consequence, the switch 61 is turned OFF, and the switch 60 is turned ON, to thereby convert all electric power generated from the power generation apparatus 5 (PV) by the converter 90 (PCS) for output. When the solar irradiance becomes 350 W/M2 or lower, the switch 61 is turned ON, and the switch 60 is turned OFF, to thereby store all the electric power output from the power generation apparatus 5 (PV) in the power storage device 20 (LIC). After the power storage device 20 (LIC) stores the output power, and the voltage of the power storage device 20 (LIC) becomes sufficiently higher, the switch 60 is turned ON while the switch 61 is kept ON to bring about a state in which electric power may be supplied to the converter 90 (PCS) by both of the power generation apparatus 5 (PV) and the power storage device 20 (LIC), and the converter 90 (PCS) provides an output. At this time, the converter 90 (PCS) may receive sufficient input power from the power storage device 20 (LIC), and hence maximum power point tracking (MPPT) control is performed to allow the output at a rated power value of the converter 90 (PCS), with the result that power conversion at high efficiency can be expected.

FIG. 4 is a flow chart for illustrating control processing of the control unit, which is used to described the above description in greater detail, and includes Steps S101 to S122, in which all the steps are performed by control processing of the control unit 90.

First, the control is started in a state in which the power generation apparatus 5 outputs electric power within a rated capacity of the converter 90. In that case, the PCS switch is “ON”, and the LI switch is “OFF” (S101). Next, the control unit 80 determines whether or not the PCS is within a rated capacity range (S102). This determination may be performed with an ammeter and a voltmeter. When the PCS is within the rated capacity range, the processing returns to Step S101. When the PCS is outside the rated capacity range, the processing proceeds to Step S103.

The control unit 80 determines whether the PCS is the rated capacity or lower or the rated capacity or higher (S103). When the PCS is the rated capacity or lower, the control unit 80 proceeds to the low-load power recovery mode (S111), and when the PCS is the rated capacity or higher, the control unit 80 proceeds to a high-load power recovery mode (S121).

B1. Low-Load Power Recovery Mode

When the output of the power generation apparatus 5 is low, the control unit 80 turns the PCS switch “OFF”, and turns the LI switch “ON” (S111). In this manner, the generated low power of the power generation apparatus 5 is stored in the power storage device but not in the PCS.

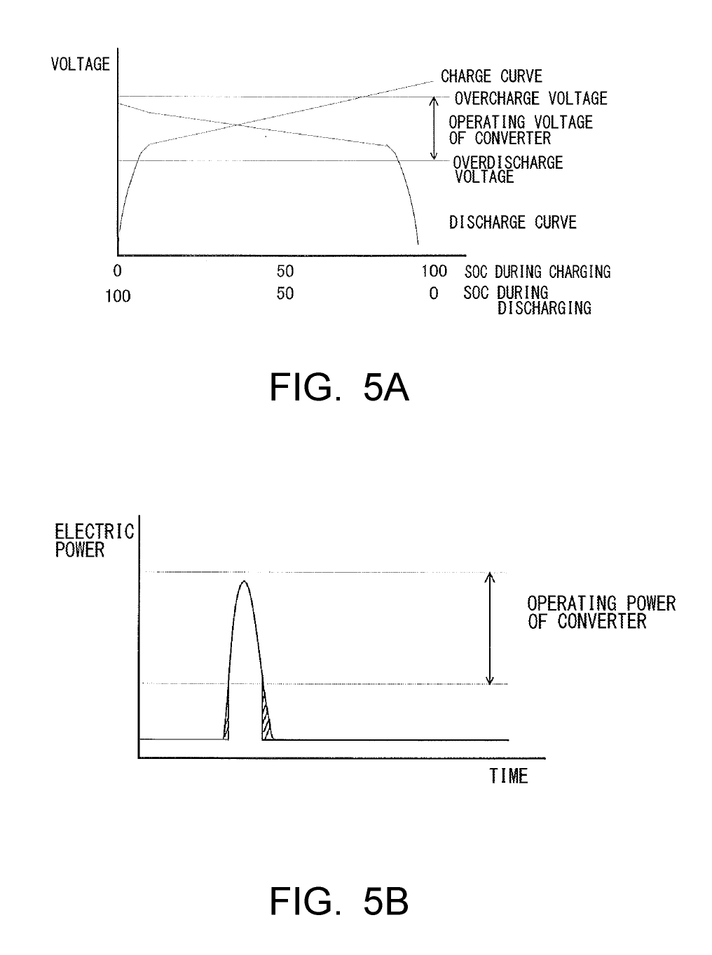

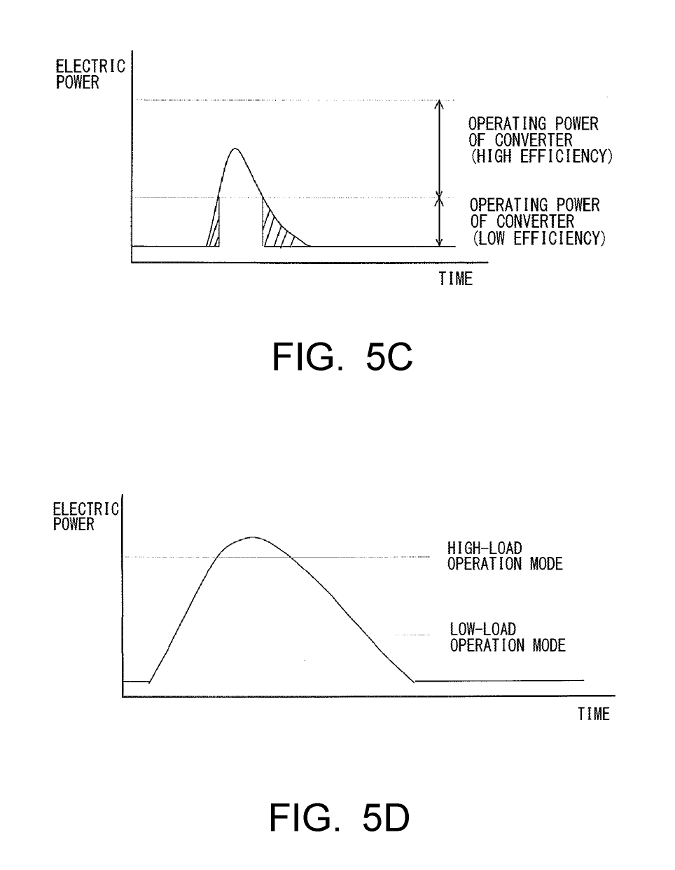

FIG. 5A is a graph for showing an example of charge and discharge curves of the power storage device according to an embodiment of the present disclosure. The curves shown in FIG. 5A are those of the lithium-ion battery, and in the case of the LIC, the SOC takes a shape that is in proportion to the square of the voltage.

FIG. 5B is a graph for showing an example of the output during discharging of the power storage device according to an embodiment of the present disclosure. FIG. 5C is a graph for showing an example of the output during discharging of a related-art battery. The related-art battery is a battery that is not configured for a power generation system. The power storage device according to an embodiment of the present disclosure is configured so that the electric power output from the power storage device falls within a rated output range of the converter faster than the related-art battery during the discharging. Therefore, the operation in the range in which the converter provides high conversion efficiency may be performed, with the result that a converter power loss caused by the low output, which is shown in FIG. 5C, may be suppressed in FIG. 5B.

Note that, the power storage device according to a first embodiment of the present disclosure has the higher charge and discharge efficiency and/or higher responsiveness than the secondary battery, and hence provides the effect as in FIG. 5B. Meanwhile, the power storage device according to a second embodiment of the present disclosure is designed as a battery so that the discharge curve falls within an operating voltage of the converter as shown in FIG. 5A.

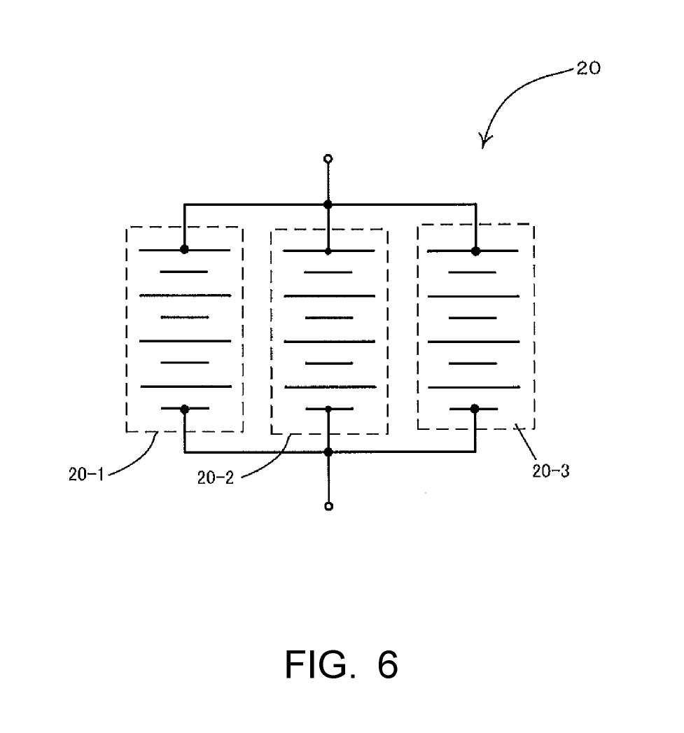

FIG. 6 is a diagram for illustrating an example structure of the power storage device according to the second embodiment. The power storage device 20 is formed of a plurality of power storage modules 20-1, 20-2, and 20-3, which are connected in parallel. The power storage modules are designed as batteries so as to have charge and discharge characteristics shown in FIG. 5A. However, the power storage modules are connected to each other in parallel, and hence the power storage device 20 as a whole may have a small internal resistance.

Note that, in addition to or separately from the battery design as described above, current control in the PCS may be performed so as to obtain a current value with which the output is not reduced even when a voltage drop occurs.

Returning back to FIG. 4, the control unit determines whether or not the voltage of the power storage device 20 is higher than an overcharge voltage (S112). When the voltage of the power storage device 20 is lower than the overcharge voltage, the processing returns back to Step S111.

When the voltage of the power storage device 20 becomes higher than the overcharge voltage (S112), the PCS switch is turned “ON”, and the LI switch is also turned “ON”, to thereby discharge electric power stored in the power storage device 20 (S113).

Further, the control unit monitors the voltage of the power storage device 20, and determines whether the voltage is higher or lower than an overdischarge voltage (S114). When the voltage is reduced by the discharging, and the power storage device voltage 20 becomes lower than the overdischarge voltage, the processing returns to Step S101, in which the PCS switch is turned “ON”, and the LI switch is turned “OFF”, to thereby end a series of processing of the “shishi-odoshi” control, and the processing is started again.

Note that, the “shishi-odoshi” control has a feature in that the LI switch may be turned ON/OFF to avoid a state in which the power storage device is always charged or discharged. When the power storage device 20 is always charged or discharged, a large charge and discharge loss becomes a problem. To address this problem, the “shishi-odoshi” control may be performed to mitigate the problem of the low charge and discharge efficiency of the secondary battery.

B2. High-Load Power Recovery Mode

When generated power of the power generation apparatus 5 is high, and is the rated capacity of the PCS or higher, the control unit 80 proceeds to the high-load power recovery mode (S121), in which the PCS switch is kept “ON”, and the LI switch is turned “ON” (S121).

FIG. 5D is a graph for showing a state in which a high load is generated. In many cases, the maximum electric power of the power generation apparatus 5 and the maximum electric power of the converter 90 are not designed to be the same. This is because a design margin for the power generation apparatus 5, which is larger than a rated value of the power generator 90, is provided, and because of other such reasons. However, as a result, in the photovoltaic power generation or the like, for example, when solar irradiation is high in the summer, the maximum electric power of the converter 90 may be exceeded. At this time, part of the generated power of the power generation apparatus 5 is lost. Electric power exceeding the high-load operation mode shown in FIG. 5D corresponds to the loss. In order to avoid such problem, the power source system 100 is configured to execute a high-load power generation mode in addition to a low-load operation mode.

Following Step 121, it is determined whether or not the voltage of the power storage device is higher than the overcharge voltage (S122), and when the voltage of the power storage device is higher than the overcharge voltage, the states of the switches are maintained (S121). Note that, it is preferred that a stored amount of the power storage device 20 be an amount of stored electric power with which enough electric power under high load may be recovered. As such power storage device 20, the LiB is more preferred than the LiC, and hence in the high-load power recovery mode, it is preferred to adopt the secondary battery.

When the voltage of the power storage device becomes lower than the overcharge voltage, the processing returns to Step S101 to end the mode.

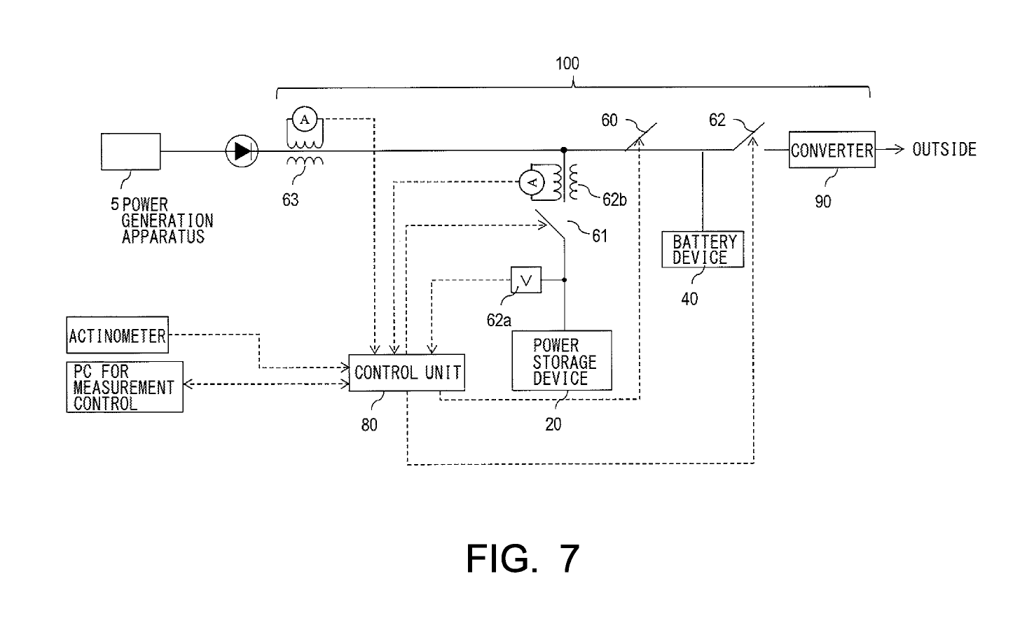

FIG. 7 is a single-line diagram for illustrating an example of the power source system, in which the power source system 100 further includes a battery device 40. In this case, the power source system 100 further includes a switch 62 for connection or disconnection that is connected upstream of the converter 90.

C. External Load Control

Load control in a case where the power source system 100 includes the battery device 40 is described. When generated power in the photovoltaic power generation or the like is larger than electric power consumed by a load, the converter 90 and the switch 62 continue to constantly supply electric power to the load and charge the power storage device 20 with surplus electric power, or the switch 60 is connected to charge the battery device 40. At this time, when the voltage of the power storage device 20 is increased, a deviation from the maximum power point of the power generation apparatus 5 occurs, with the result that the MPPT efficiency is lowered. Meanwhile, when the converter 90 and the switch 62 are used to supply electric power to the outside, electric energy is lost by an amount equal to the efficiency of the converter 90 and charge and discharge efficiency of the battery device 40. Moreover, when the converter 90 is operated to transport a low electric current, the conversion efficiency of the converter itself is significantly reduced.

In view of this, a loss due to the reduction in conversion efficiency (opportunity loss caused by the inability to generate electric power in spite of the presence of a wind or solar radiation) and a loss of the output of the converter 90 to the outside (converter efficiency in consideration of even the fact that the conversion efficiency is varied with the transported current, and the charge and discharge efficiency of the battery device) are calculated and compared with each other, and the control unit 80 selects a smaller loss.

In a case where the electric power consumed by the load is higher than the generated power in the photovoltaic power generation or the like, and when an output of the wind or photovoltaic power generation or the like is available, the converter 90 and the switch 62 continue to constantly supply electric power equal to the output of the photovoltaic power generation or the like to the load with electric power, and additional discharge is performed from the power storage device via the converter 90 and the switch 62 for insufficient electric power. A reduction in the MPPT efficiency caused by a reduction in voltage of the power storage device, and a conversion loss in the converter 90 and the switch 62 (unlike the above, the charge and discharge efficiency of the battery device is not included. The battery device is in a state of being discharged, and hence electric power that has been conveyed by the switch 60 is not stored in the secondary battery) are calculated and compared with each other, and the control unit 80 selects a smaller loss.

6. Battery

The battery device 40 is, for example, the lithium-ion battery, the nickel-metal hydride battery, or the lead battery shown in Table 1. The battery device 40 is configured to store electric power discharged by the power storage device. The battery device 40 is configured to perform charge and discharge operations depending on an electric power demand of the outside.

7. Power Source System Configured to Receive Electric Power from Wind Power Generator

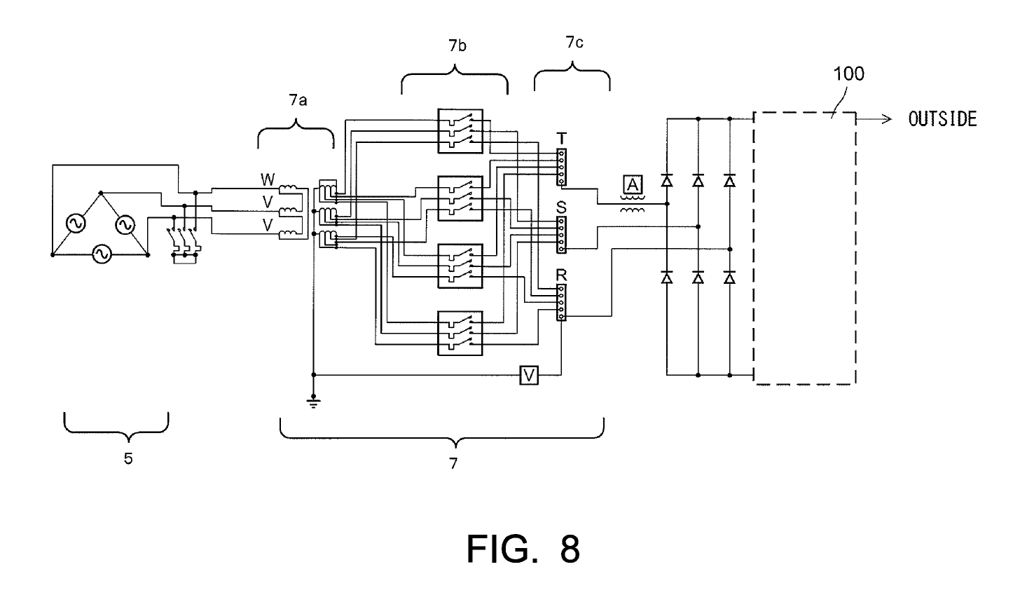

FIG. 8 is a diagram for illustrating an example structure of a power source system configured to receive electric power from the wind power generator. The wind power generator is an alternating-current (AC) power source, and hence the power source system 100 illustrated in FIG. 8 is connected to the power generation apparatus 5, which is the alternating-current power source as the wind power generator, through a transformer and rectifier 7. The transformer and rectifier 7 illustrated in FIG. 8 includes a four-tap switchover transformer 7A, a tap switchover electromagnetic switch 7B, and a rectifier 7C. The four-tap switchover transformer 7A is configured to perform a voltage conversion so that an output voltage of the power generation apparatus 5 falls within a range between upper limit and lower limit voltages of the power storage device 20. The tap switchover electromagnetic switch 7B is configured to select a voltage to be applied to the power storage device 20 depending on the output voltage of the power generation apparatus 5. The rectifier 7C is configured to convert AC power from the power generation apparatus 5, which is configured to supply an AC output, into DC power.

As illustrated in FIG. 8, the power storage device 20 may be connected in series to correspond to the voltage of the wind power generator.

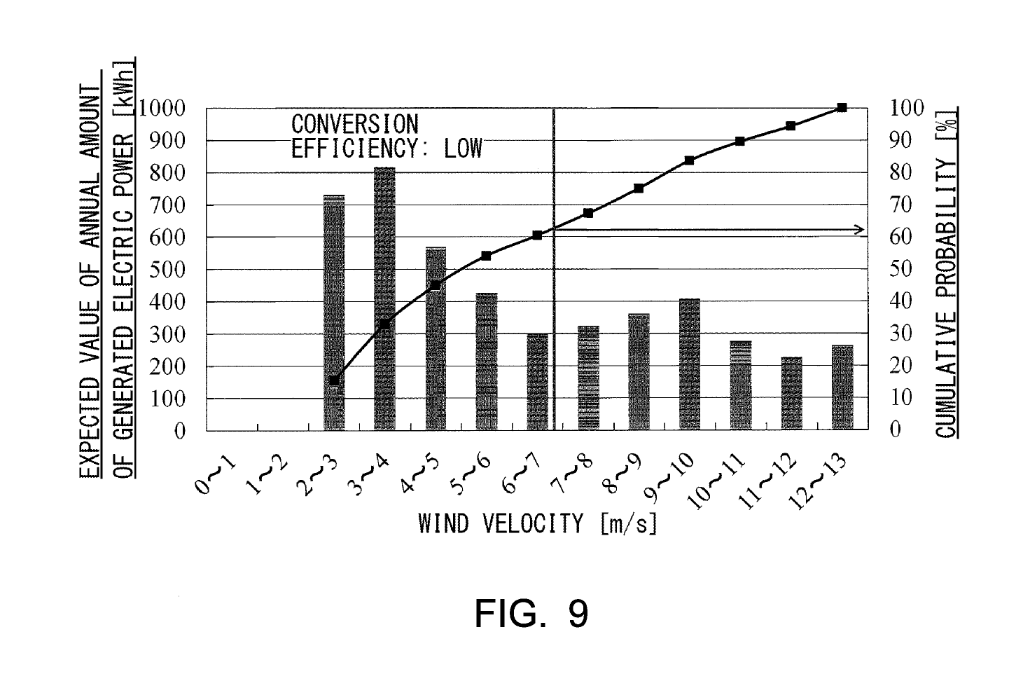

FIG. 9 is a graph for showing a relationship between the wind power generation and wind velocities. On the land, most winds blow at wind velocities of from 2 M to 4 M in general. Many types of wind power generators capable of generating electric power from those low-velocity winds have been developed in recent years, but electric power generated from the wind power generator cannot be used because the power conversion efficiency of a power converter connected to the wind power generator is significantly reduced. Therefore, it has been impossible to use electric power generated from winds having velocities of from 0 M to 4 M, which appears frequently and accounts for a large proportion of the amount of electric power generated throughout the year.

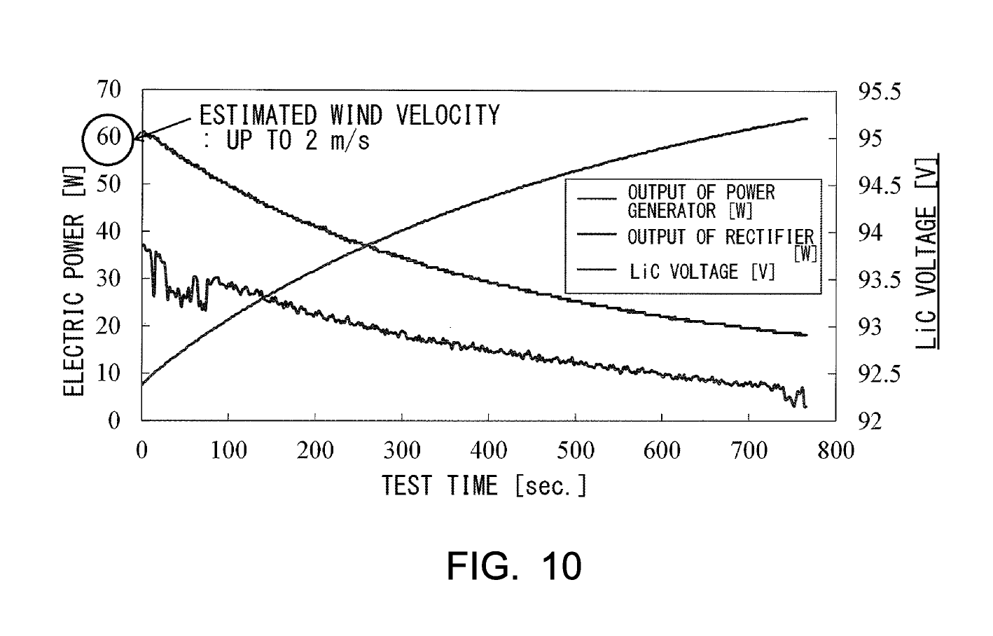

FIG. 10 is a graph for showing an example of electric power generated in the wind power generation and electric power receiving capacity of the power source system. A lithium-ion capacitor is used as the power storage device. As shown in FIG. 9, the power source system 100 is capable of storing electric power even under low wind velocity, and hence of storing electric power generated from winds at velocities of from 0 M to 4 M, which can be expected to account for a large proportion of an annual total amount of generated electric power shown in FIG. 9.

### EXAMPLES

The structure in FIG. 1 was used to conduct a test in which a highly efficient energy recovery function under low electric current without the converter of the power source system 100 was used to recover electric power in a power generation state under low electric current with a solar irradiance of 350 W/M2 or lower, at which the conversion efficiency of the PCS was reduced. A test apparatus includes a PV as the power generation apparatus 5, a PCS as the converter 90, a lithium-ion capacitor (LIC) for recovering low output power under partial load as the power storage device 20, the actinometer, and a PC for measurement control. As the LIC, forty ULTIMO 2200F cells, which are manufactured by JM Energy (trademark) and connected in series, were used.

FIG. 11 is a graph for showing the solar irradiance obtained from the actinometer. The solar irradiance from the actinometer in FIG. 11 is measured, and when the solar irradiance is 350 W/M2 or higher, it is determined that the converter 90 (PCS) provides the sufficient conversion efficiency. Accordingly, the switch 61 is turned OFF, and the switch 60 is turned ON, to thereby convert all the electric power generated from the power generation apparatus 5 (PV) by the converter 90 (PCS) for output. When the solar irradiance becomes 350 W/M2 or lower, the switch 61 is turned ON, and the switch 60 is turned OFF, to thereby store all the electric power output from the power generation apparatus 5 (PV) in the power storage device 20 (LIC). After the power storage device 20 (LIC) stores the output power, and the voltage of the power storage device 20 (LIC) becomes sufficiently higher, the switch 60 is turned ON while the switch 61 is kept ON to bring about a state in which electric power may be supplied to the converter 90 (PCS) by both of the power generation apparatus 5 (PV) and the power storage device 20 (LIC), and the converter 90 (PCS) provides the output. At this time, the converter 90 (PCS) may receive sufficient input power from the power storage device 20 (LIC), and hence the maximum power point tracking (MPPT) control is performed to allow the output at the rated power value of the converter 90 (PCS), with the result that power conversion at high efficiency can be expected.

Conversion Efficiency of PCS

With the structure in which eight PV panels “NU-180” manufactured by SHARP (trademark) are connected in series and one in parallel, a solar irradiance-conversion efficiency (=AC output power/DC input power) curve was measured for SUNNY BOY 3500TL-JP manufactured by SMA.

FIG. 12 is a graph for showing a measurement result of the conversion efficiency in accordance with the solar irradiance. As shown in FIG. 12, it can be seen that conversion efficiency of about 85% to 90% is obtained when the solar irradiance is 600 W/M2 to 900 W/M2, but that the conversion efficiency is reduced abruptly under partial load of about 350 W/M2 or lower (conversion efficiency of about 80%). This result shows that it is preferred that, when the maximum power conversion efficiency of the converter is set to 1, the rated output range of the PCS be a range in which the power conversion efficiency of the converter is 80% to 100%, and that, when the power conversion efficiency becomes less than 80%, the power conversion efficiency be determined to be a PCS rated capacity or smaller, and a transition be made to a low-load mode.

Test Result

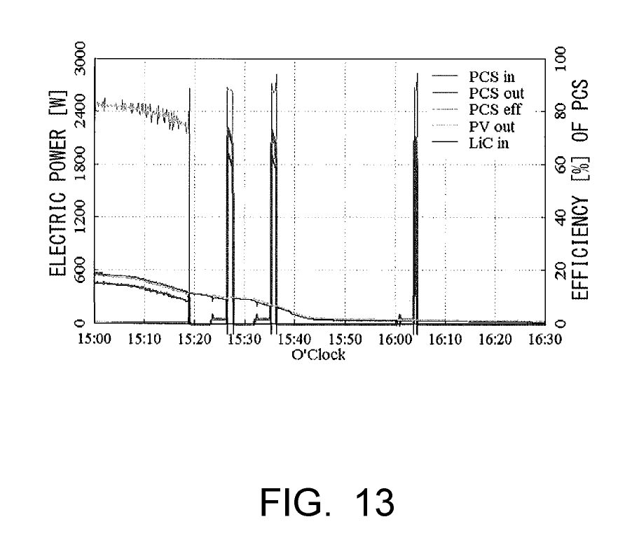

FIG. 13 is a graph for showing a result of a conversion efficiency improvement test under partial load of the converter. It can be seen from FIG. 13 that the solar irradiance was reduced as the evening approached, and that the conversion efficiency of the converter 90 (PCS) was reduced accordingly. It can be seen that the solar irradiance falls below 350 W/M2 before around 15:20, and that the switch 60 and the switch 61 illustrated in FIG. 1 are turned OFF and ON, respectively, to thereby stop the input and the output of the converter 90 (PCS), and to store the output of the power generation apparatus 5 (PV) by the power storage device 20 (LIC) instead. At this time, it can be seen that the power generation apparatus 5 (PV) continued to provide an output comparable to the output that had been provided without stopping the power generation. This is attributable to the high charge and discharge efficiency as high as 99.4% of the power storage device 20 (LIC). While in this state, it can be seen that the voltage of the power storage device 20 (LIC) was increased until 15:25, and that after the power storage device 20 (LIC) had stored sufficient electric power, the switch 60 was turned ON to connect the power generation apparatus 5 PV) and the power storage device 20 (LIC) to the converter 90 (PCS), and then the converter 90 (PCS) waited for the start of the output operation of the converter 90 (PCS) to provide the output at high conversion efficiency of about 92% or higher. At this time, the power storage device 20 (LIC) functioned as a power source capable of retrieving the electric current to the greatest extent possible for the converter 90 (PCS). Therefore, electric energy stored in the power storage device 20 (LIC) was output after being increased by the MPPT operation of the converter 90 (PCS) to enable the output at efficiency that is close to the rating of the converter 90 (PCS). It can also be seen that, at this time, the power generation apparatus 5 (PV) continued outputting, and it was possible to utilize opportunities and the power generation capacity of the power generation apparatus 5 (PV) to the fullest.

Thereafter, the so-called “shishi-odoshi” like operation, in which the power storage device 20 (LIC) was charged from the power generation apparatus 5 (PV) in a low-current power generation state, and in which the output at high efficiency was provided at once by the converter 90 (PCS), was repeated until the sunset, and it can be seen that the power recovery and the output at high efficiency were possible even in a low solar irradiance environment of from about 100 W/M2 to about 200 W/M2 or lower, in which the converter 90 (PCS) was otherwise unable to continue the output operation.

An output assisting test apparatus for a photovoltaic panel and a power conditioner subsystem for photovoltaic power generation, to which functions of a battery-capacitor hybrid battery system were applied, was fabricated. The functions allow the use of unused energy and the output at high efficiency by recovering a low current output of the photovoltaic power generation, which has been difficult to use in the related-art power converter, by a capacitor to be output at a rated value of the power converter.

As a result of the conversion efficiency improvement test under partial load of the power converter by means of recovering the low output power and increasing the output with the use of the capacitor, it was empirically demonstrated that the electric power generated by the photovoltaic panel under low solar irradiance of 350 W/M2 or lower, at which conversion efficiency of the power conditioner subsystem is reduced to 80% or lower, was recovered and stored by the lithium-ion capacitor at high efficiency of 99.4%, and was output at the rated output of the power conditioner subsystem to enable the output at the high conversion efficiency of about 92% or higher.

The above-mentioned embodiments are merely given as typical examples, and combinations, modifications, and variations of the constituent elements in the embodiments will be apparent to those skilled in the art, and it will be apparent to those skilled in the art that various modifications may be made to the above-mentioned embodiments without departing from the spirit of the present disclosure and the scope of the disclosure as defined in the claims.

### DESCRIPTION OF REFERENCE SIGNS

5 power generation apparatus
20 power storage device
40 battery device
60˜62 switch portion
80 control unit
90 converter
100 power source system

1. A power source system, which is configured to receive an electric power from a power generation apparatus having a varying output, and to output the electric power which is received to a converter, and the power source system comprising:
a power storage device, configured to store the electric power of the power generation apparatus, and to discharge the electric power which is stored;
a first switch portion, provided on a wiring line connecting the power generation apparatus and the converter;
a second switch portion, provided between a point between the power generation apparatus and the first switch portion on the wiring line, and the power storage device; and
a control unit, configured to control a connection or disconnection operation of the first switch portion and the second switch portion,
wherein the control unit is configured to:
disconnect the first switch portion and connect the second switch portion, so as to perform a charging to the power storage device with the electric power output from the power generation apparatus, when an output current of the power generation apparatus is a low current; and
control the connection or disconnection operation of the first switch portion and the second switch portion, so that each of the first switch portion and the second switch portion is put into a connected state to output the electric power stored in the power storage device to the converter, when a voltage of the power storage device becomes higher than an operating voltage of the converter as a result of the charging.

2. A power source system according to claim 1, further comprising:
a battery device, arranged between the converter and the power storage device,
wherein the battery device further includes: a battery device configured to store an electric power at a voltage that is lower than a voltage of the electric power discharged from the power storage device.

3. A power source system according to claim 1, wherein
the control unit is configured to calculate the electric power of the power generation apparatus by using a voltage sensor and a current sensor, and to control the first switch portion so as to maximize the electric power from the power generation apparatus.

4. A power source system according to claim 1,
wherein the control unit is configured to:
disconnect the first switch portion and connect the second switch portion, when the electric power of the power generation apparatus is changed to fall below a lower limit value of a rated output range of the converter; and
perform in a control so that the first switch portion and the second switch portion are connected to perform a discharging of the electric power stored in the power storage device, when a voltage of the power storage device falls within an MPPT control voltage of the converter as a result of connecting the second switch portion, and
wherein the power storage device is configured so that the electric power output from the power storage device falls within the rated output range of the converter during the discharging.

5. A power source system according to claim 1, wherein
the power storage device has an internal resistance with which the electric power does not fall outside the rated output range of the converter, due to a voltage drop of the power storage device during the discharging.

6. A power source system according to claim 5, wherein
the power storage device is formed of a plurality of power storage modules, and the plurality of power storage modules are connected in parallel.

7. A power source system according to claim 1, wherein
the converter is configured to control an electric current so that the electric power does not fall outside the rated output range of the converter, due to a voltage drop of the power storage device during the discharging of the power storage device.

8. A power source system according to claim 1, wherein
the rated output range is 80% to 100% of a rating of the converter.

9. A power source system according to claim 1, wherein
the control unit is configured to disconnect the first switch portion and connect the second switch portion to stop the discharging, after the discharging and before a voltage of the electric power output from the power storage device becomes a lower limit value of the rated output range of the converter.

10. A power source system according to claim 4, wherein
the control unit is configured to connect the first switch portion and the second switch portion, when the electric power of the power generation apparatus is changed to exceed an upper limit of the rated output range of the converter.

11. A power source system according to claim 1, wherein
the power storage device has a higher charge and discharge efficiency and/or a higher responsiveness than a secondary battery.

12. A power source system according to claim 1, wherein
the power storage device is a lithium-ion capacitor or an electric double layer capacitor.

13. A power source system according to claim 1, wherein
the power storage device is a secondary battery.

14. A power source system according to claim 1, wherein
the power generation apparatus comprises a photovoltaic power generation apparatus or a wind power generation apparatus.

15. A control method for a power source system configured to receive an electric power from a power generation apparatus having a varying output, and to output the electric power which is received to a converter,
the power source system comprising:
a power storage device, configured to store the electric power of the power generation apparatus, and to discharge the electric power which is stored; a first switch portion, provided on a wiring line connecting the power generation apparatus and the converter; a second switch portion, provided between a point between the power generation apparatus and the first switch portion on the wiring line, and the power storage device; and a control unit, configured to control a connection or disconnection operation of the first switch portion and the second switch portion,
wherein the control unit being configured to:
disconnect the first switch portion and connect the second switch portion, so as to perform a charging to the power storage device with the electric power output from the power generation apparatus, when an output current of the power generation apparatus is a low current; and
control the connection or disconnection operation of the first switch portion and the second switch portion, so that each of the first switch portion and the second switch portion is put into a connected state to output the electric power stored in the power storage device to the converter, when a voltage of the power storage device becomes higher than an operating voltage of the converter as a result of the charging.

16. A control method according to claim 15, wherein
the control unit is configured to calculate the electric power of the power generation apparatus by using a voltage sensor and a current sensor, and to control the first switch portion so as to maximize the electric power from the power generation apparatus.

17. A control method according to claim 15,
wherein the control unit is configured to:
disconnect the first switch portion and connect the second switch portion, when the electric power of the power generation apparatus is changed to fall below a lower limit value of a rated output range of the converter; and
perform a control so that the first switch portion and the second switch portion are connected to perform a discharging of the electric power stored in the power storage device, when a voltage of the power storage device falls within an MPPT control voltage of the converter as a result of connecting the second switch portion, and
wherein the power storage device is configured so that the electric power output from the power storage device falls within the rated output range of the converter during the discharging.

18. A control method according to claim 15, wherein
the control unit is configured to disconnect the first switch portion and connect the second switch portion to stop the discharging, after the discharging and before a voltage of the electric power output from the power storage device becomes a lower limit value of the rated output range of the converter.

19. A control method according to claim 17, wherein
the control unit is configured to connect the first switch portion and the second switch portion, when the electric power of the power generation apparatus is changed to exceed an upper limit of the rated output range of the converter.
